(19) United States
(12) Patent Application Publication
(10) Pub. No.: US 2024/0253048 A1
(43) Pub. Date: Aug. 1, 2024

(54) THERMAL CONTROL SYSTEM FOR DEVICE THAT MEASURES FLUID VISCOSITY

(71) Applicant: Medtronic, Inc., Minneapolis, MN (US)

(72) Inventors: Brian Joseph Ferry, Saint Louis Park, MN (US); Samuel A. Bartholomew, Brooklyn Park, MN (US); Shana L. Sommerfeldt, Crystal, MN (US); Michael L. Laxen, Minneapolis, MN (US); Nicholas Hofmann, Shorewood, MN (US); Douglas John Zimmerman, Fridley, MN (US); Russell J. Kuenzi, Saint Louis Park, MN (US)

(21) Appl. No.: 18/425,154

(22) Filed: Jan. 29, 2024

Related U.S. Application Data
(60) Provisional application No. 63/482,171, filed on Jan. 30, 2023.

(51) Int. Cl. B01L 3/00; G01N 11/00

(52) U.S. Cl. CPC B01L 3/50851; B01L 2200/147; B01L 2300/1805; G01N 2011/002

(57) ABSTRACT

A thermal control system is provided for monitoring and maintaining the temperature of a fluid sample within a cartridge having a plurality of wells. The thermal control system includes a heater block assembly having a cartridge slot sized and shaped to receive the cartridge within the heater block assembly. The heater block assembly is comprised of thermally conductive material. The thermal control system also includes a printed circuit board assembly coupled to the heater block assembly. The printed circuit board assembly is configured to generate heat and deliver the heat to the heater block assembly. The heater block assembly is configured to distribute the heat to the fluid sample located within the wells of the cartridge.

### CROSS-REFERENCE TO RELATED APPLICATIONS

This application claims priority to U.S. Application No. 63/482,171, filed Jan. 30, 2023, the entire contents of which are incorporated herein by reference.

### FIELD

The present technology is generally related to devices for measuring the viscosity of a fluid, such as blood.

### BACKGROUND

Hemostasis management plays an important role in the health and well-being of the circulatory system. Current devices for hemostasis management measure blood factors, some by changes in viscosity while agitating a blood sample, so that appropriate dosages of heparin, protamine, or other substances may be prescribed to bring the blood to desired levels of coagulation. Such devices commonly include the use of a cartridge having wells that receive the blood sample. The cartridges further include ferromagnetic elements that are moved through the blood within the wells. The devices measure the time required to move the ferromagnetic elements through the blood, and thereby determine a viscosity of the blood sample. Examples of such devices are described, for example, in U.S. Pat. Nos. 5,629,209 and 6,613,286, the entire contents of which are incorporated herein by reference.

### SUMMARY

The techniques of this disclosure generally relate to the use of a thermal control system to monitor and maintain the temperature of a fluid sample (e.g., blood) in a device that measures fluid viscosity.

In one aspect, the present disclosure provides a thermal control system for monitoring and maintaining a temperature of a fluid sample within a cartridge having a plurality of wells. The thermal control system includes a heater block assembly having a cartridge slot sized and shaped to receive the cartridge within the heater block assembly. The heater block assembly is comprised of thermally conductive material. The thermal control system also includes a printed circuit board assembly coupled to the heater block assembly. The printed circuit board assembly is configured to generate heat and deliver the heat to the heater block assembly. The heater block assembly is configured to distribute the heat to the fluid sample located within the wells of the cartridge.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a perspective, exploded view of a cartridge for a device that measures fluid viscosity, according to one example.

FIG. 2 is a top plan view of the cartridge.

FIG. 3 is a perspective view of the cartridge.

FIG. 4 is a perspective view of a thermal control system for the cartridge, according to one example.

FIG. 5 is a perspective view of the cartridge, illustrating flat surfaces to increase thermal contact with the thermal control system.

FIG. 6 is an exploded, top perspective view of a portion of the thermal control system.

FIG. 7 is bottom perspective view of the thermal control system.

FIG. 8 is a partial, perspective, cross-sectional view of the device that measures fluid viscosity, illustrating an electromagnet, a cartridge disc, and a position sensor.

FIG. 9 is a cross-sectional view of a portion of the device that measures fluid viscosity, illustrating a magnetic field and an induction field, and illustrating an alignment and concentricity of the cartridge disc with the electromagnet.

FIG. 10 is a perspective view of the cartridge being aligned for insertion into the thermal control system.

FIG. 11 is a perspective view of alignment features for aligning the cartridge with the thermal control system.

FIGS. 12-18 are perspective views of retention features for retaining the cartridge within the thermal control system.

FIGS. 19-25 are top plan and perspective views of detection features on the cartridge for detecting the cartridge within the thermal control system.

FIG. 26 is a block diagram of the thermal control system for controlling the temperature of the heater block assembly.

FIG. 27 is a flow chart of a method for controlling the temperature of the heater block assembly.

FIG. 28 is a flow chart of a method for performing an over-temperature operation for the heater block assembly.

FIGS. 29 and 30 are perspective views of a removable slot housing for the cartridge.

FIG. 31 is a perspective view of elliptical-shaped wells in the cartridge, and standoffs at the bottoms of the wells.

FIG. 32 is a perspective view of a ramped inlet for one of the wells.

FIG. 33 is a schematic view of an automated vacuum fill system.

FIG. 34 is a perspective view of an external fluid reservoir.

FIG. 35 is a perspective view of a vacuum fill cartridge port.

### DETAILED DESCRIPTION

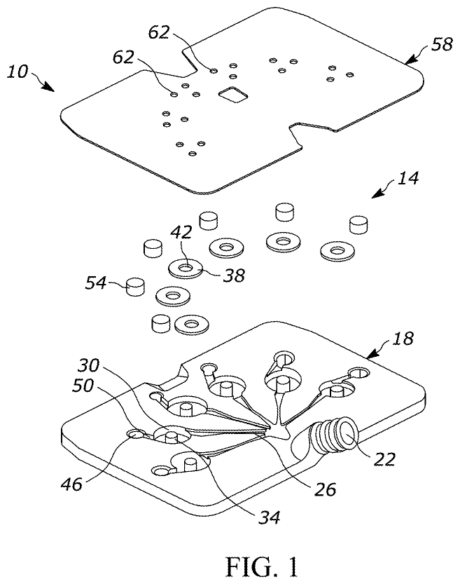

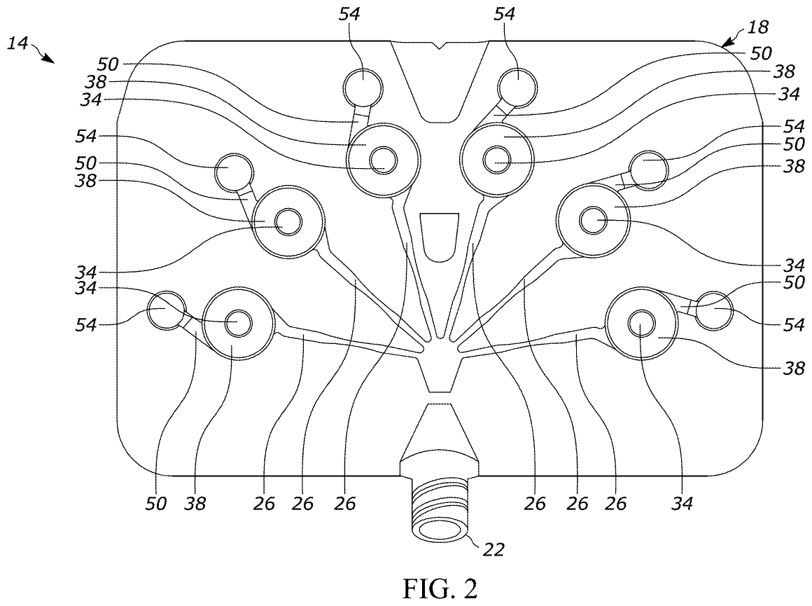

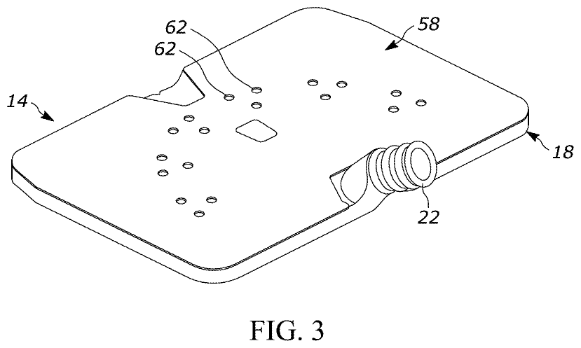

With reference to FIGS. 1-3, a device 10 is used to measure the viscosity of a fluid (e.g., blood, industrial fluid, oil, food product liquid, etc.). The device 10 includes a cartridge 14 (e.g., disposable cartridge) having a main body 18, and an injection port 22 coupled to the main body 18 (e.g., integrally formed as a single piece with the main body 18). The injection port 22 is used to introduce a fluid sample into the cartridge 14. The main body 18 of the cartridge 14 includes a plurality of inlet conduits 26 that extend away from the injection port 22, and a plurality of wells 30. In some examples, the main body 18 is formed of a plastic or acrylic, although other examples may include other materials.

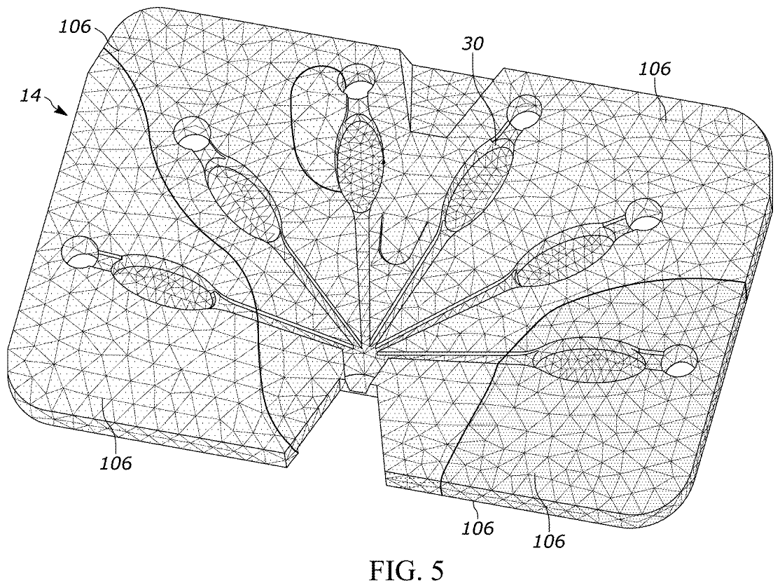

In the illustrated example, each of the wells 30 is generally circular in shape, and includes a center post 34, although in other examples the wells 30 are oval-shaped (FIG. 5), or have other shapes than that illustrated. The inlet conduits 26 extend from the injection port 22 to the wells 30, and deliver fluid from the injection port 22 to the wells 30 (e.g., simultaneously). Other examples include different numbers and arrangements of inlet conduits 26 and wells 30 than that illustrated. For example, in some examples the cartridge 14 includes fewer than six wells 30 (e.g., two wells 30, or three wells 30), and in other examples the cartridge 14 includes more than six wells 30 (e.g., eight wells 30, or ten wells 30).

With continued reference to FIGS. 1-3, the cartridge 14 also includes a plurality of ferromagnetic elements 38 (e.g., discs) that are sized and shaped to fit within the wells 30 of the main body 18. In the illustrated example, each of the ferromagnetic elements 38 is a washer-like disc, having a circular shape and a central aperture 42. The ferromagnetic elements 38 are sized and shaped such that the central apertures 42 fit over the center posts 34, and such that the ferromagnetic elements 38 are movable within the wells 30 (e.g., vertically up and down). During operation of the device 10 (e.g., when the cartridge 14 has been inserted), each of the ferromagnetic elements 38 may be raised under a magnetic action within the well 30, and then allowed to fall through the liquid (e.g., blood) within the well 30. One or more characteristics (e.g., the time it takes for the ferromagnetic element 38 to fall through the liquid) may be measured by detecting the position of the ferromagnetic element 38. The ferromagnetic elements 38 may be raised and lowered repeatedly, and the timing may be measured, to detect a viscosity level of the fluid within the well 30, and to detect a change in viscosity (e.g., coagulation, or blood clot) over time. Other examples include other numbers and shapes of ferromagnetic elements 38 than that illustrated (e.g., oval-shaped ferromagnetic elements 38).

With continued reference to FIGS. 1-3, the main body 18 of cartridge 14 also includes a plurality of air vent apertures 46, and a plurality of outlet conduits 50 that extend from the wells 30 to the air vent apertures 46. The cartridge 14 includes a plurality of air vent/fluid plug devices 54 that are positioned (e.g., pressed) at least partially within the air vent apertures 46. Each of the air vent/fluid plug devices 54 inhibits, or prevents, fluid from passing further through the air vent aperture 46, but allows air to pass therethrough and into (e.g., through) the air vent aperture 46. In some examples, the air vent/fluid plug device 54 forms a permanent liquid lock. In some examples, the air vent/fluid plug device 54 is formed from plastic (e.g., Porex® plastic), although other examples include other types of material.

With continued reference to FIGS. 1-3, the cartridge 14 also includes a cover 58 that is coupled (e.g., via heat sealing) to the main body 18 of the cartridge 14. In some examples, the cover 58 is more flexible than the main body 18, is thinner than the main body 18, and/or is formed of a different material than the main body 18. In the illustrated example, the cover 58 includes a plurality of dimples 62. The dimples 62 are positioned above the wells 30, and project inwardly (i.e., toward the wells 30) when the cover 58 is coupled to the main body 18. The dimples 62 provide points of contact for the ferromagnetic elements 38, such that when the ferromagnetic elements 38 rise up within the wells 30 under magnetic force, the ferromagnetic elements 38 engage only the surface of the dimples 62, rather than engaging an entire planar region of the cover 58. This may advantageously inhibit or prevent the ferromagnetic elements 38 from sticking to the cover 58. Other examples include different number or arrangements of dimples 62, or include no dimples 62.

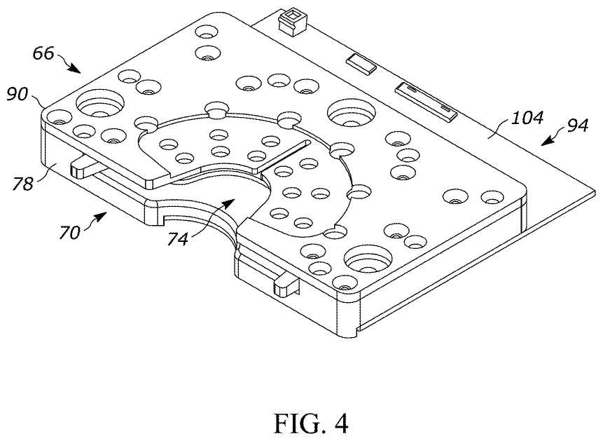

With reference to FIGS. 4-7, the device 10 also includes a thermal control system 66 for monitoring and maintaining the temperature of the fluid sample within the cartridge 14. Monitoring and maintaining the temperature of the fluid sample may facilitate consistent, predictable, and/or accurate measurements of the viscosity of the fluid sample within the cartridge during testing. In some examples, the thermal control system 66 may be used to maintain the temperature of a blood sample at 37° C., or between 36° C. and 38° C., or between 35° C. and 39° C. during testing of the blood sample. Other examples include other values or ranges of values, including other values and ranges of values for fluids other than blood. In some examples, the thermal control system 66 may be used to warm the blood sample up to a temperature that is equivalent to body temperature, and/or maintain the temperature of the blood sample at body temperature, such that testing of the blood sample may accurately determine a clotting time of the blood sample relative to the blood being within a patient's body.

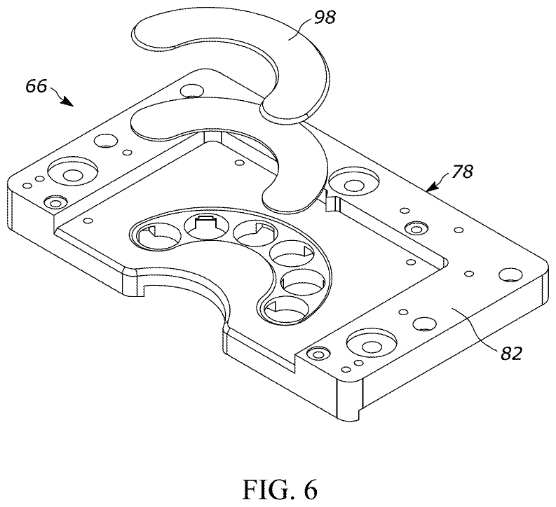

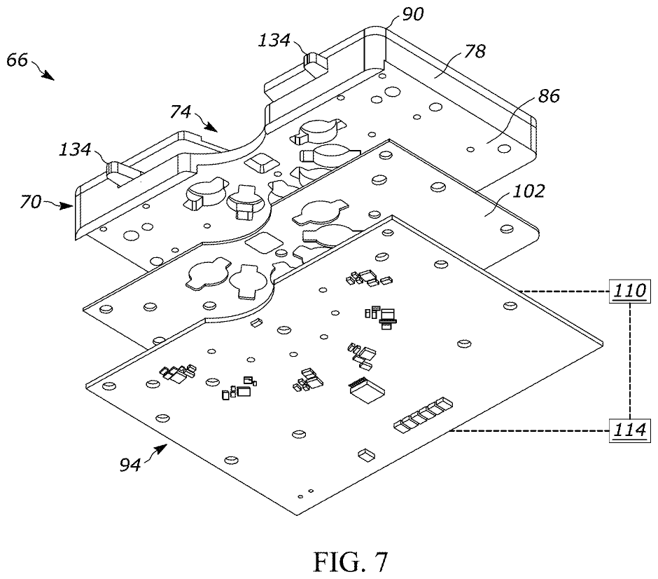

In the illustrated example, the thermal control system 66 includes a heater block assembly 70 having a cartridge slot 74 that is sized and shaped to receive the cartridge 14. The heater block assembly 70 is comprised of thermally conductive material (e.g., aluminum or copper), and includes a main body 78 having an upper surface 82 (FIG. 6) and a lower surface 86 (FIG. 7). The heater block assembly 70 additionally includes an upper plate 90 (e.g., thin plate) coupled to the upper surface 82 of the main body 78. In some examples, the upper plate 90 is integrally formed as a single piece with the main body 78. The main body 78 and the upper plate 90 together define the cartridge slot 74.

With continued reference to FIGS. 4-7, the thermal control system 66 additionally includes a printed circuit board assembly 94. The printed circuit board assembly 94 is coupled to the heater block assembly 70. The printed circuit board assembly 94 generates heat and delivers the heat to the heater block assembly 70. The heater block assembly 70 distributes the heat to the fluid sample located within the wells 30 of the cartridge 14. In the illustrated example, the printed circuit board assembly 94 is coupled to the lower surface 86 of the main body 78. The printed circuit board assembly 94 includes a plurality of copper traces (or other heat-generating electronics components) that generate the heat to be delivered from the printed circuit board assembly 94 to the heater block assembly 70. In other examples, heat may be supplied to the heater block assembly 70 from a different source, other than the printed circuit board assembly 94 (e.g., from one or more heating elements that are not located on the printed circuit board assembly 94).

With continued reference to FIGS. 4-7, in the illustrated example the thermal control system 66 includes a first intermediary plate 98 (FIG. 6) coupled to the main body 78 of the heater block assembly 70. The first intermediary plate 98 is sized and shaped to be positioned between the wells 30 of the cartridge 14 and the main body 78 of the heater block assembly 70 when the cartridge 14 is received within the cartridge slot 74. In some examples, the first intermediary plate 98 comprises a ceramic material and/or a material different than the material of the heater block assembly 70. The first intermediary plate 98 is sized, shaped, and formed of a material, such that the first intermediary plate 98 distributes (e.g., uniformly distributes) the heat from the heater block assembly 70 to the wells 30 (e.g., to equilibrate the temperature of the liquid within the wells 30). In some examples, the first intermediary plate 98 slows the distribution of heat (as compared to the rate of distribution of heat in the heater block assembly 70), such that the heat from the heater block assembly 70 moves more slowly, and evenly, and distributes through the first intermediary plate 98 to each of the wells 30. As illustrated in FIG. 6, the first intermediary plate 98 may have a crescent-shape, and may have a thickness less than that of the main body 78 of the heater block assembly 70, such that the first intermediary plate 98 extends below each of the wells 30. Other examples include other shapes and sizes for the intermediary plate 98 than that illustrated (e.g., linear, rectangular, etc.). In some examples, the thermal control system 66 does not include the first intermediary plate 98.

With continued reference to FIGS. 4-7, in the illustrated example the thermal control system 66 additionally includes a second intermediary plate 102 (FIG. 7) that is positioned between an upper surface 104 (FIG. 4) of the printed circuit board assembly 94 and the lower surface 86 of the main body 78 of the heater block assembly 70. In some examples, the second intermediary plate 102 comprises a silicone material and/or a material different than the material of the heater block assembly 70 and the printed circuit board assembly 94. The second intermediary plate 102 is sized, shaped, and comprised of a material such that the second intermediary plate 102 distributes (e.g., uniformly distributes) heat from the printed circuit board assembly 94 to the heater block assembly 70. In some examples, the second intermediary plate 102 slows the distribution of heat (as compared to the rate of distribution of heat in the printed circuit board assembly 94), such that the heat from the printed circuit board assembly 94 moves more slowly, and evenly, and distributes through the second intermediary plate 102 to the heater block assembly 70. As illustrated in FIG. 7, the second intermediary plate 102 may have a generally rectangular shape, and may have a thickness less than that of the main body 78 of the heater block assembly 70 and less than that of the printed circuit board assembly 94. Other examples include other shapes and sizes for the second intermediary plate 102 than that illustrated (e.g., square, etc.). In some examples, the thermal control system 66 does not include the second intermediary plate 102.

As illustrated in FIG. 5, the main body 18 of the cartridge 14 itself may generally include large, flat surfaces 106 (e.g., along a bottom and/or top of the main body 18) that facilitate rapid heat exchange with the heater block assembly 70. The main body 18 of the cartridge 14 may be shaped, for example, overall to maximize an amount of surface area on the cartridge 14, to increase thermal contact with the heater block assembly 70 and/or the first intermediary plate 98 and/or the second intermediary plate 102. The surfaces 106 on the main body 18 of the cartridge 14 may reduce the time needed to warm a blood sample up to body temperature and/or may facilitate equilibrating the temperature of the liquid within the wells 30.

With continued reference to FIGS. 4-7, in the illustrated example the thermal control system 66 additionally includes a temperature sensor or sensors 110 (illustrated schematically in FIG. 7). The temperature sensor 110 monitors a temperature of the heater block assembly 70, and/or the printed circuit board assembly 94, and/or the first intermediary plate 98, and/or the second intermediary plate 102. The temperature sensor 110 is coupled, for example, to the printed circuit board assembly 94. In other examples the temperature sensor 110 is coupled to the heater block assembly 70, or the first intermediary plate 98, or the second intermediary plate 102. In some examples, the thermal control system 66 includes a plurality of temperature sensors 110 coupled to one or more of the heater block assembly 70, the printed circuit board assembly 94, the first intermediary plate 98, or the second intermediary plate 102. The temperature sensor or sensors 110 are coupled, for example, to a controller 114 (illustrated schematically in FIG. 7). The controller 114 receives a signal or signals from the temperature sensor(s) 110 regarding the measured temperature(s), and controls a level of power/heat output from the printed circuit board assembly 94, based on the measured temperature.

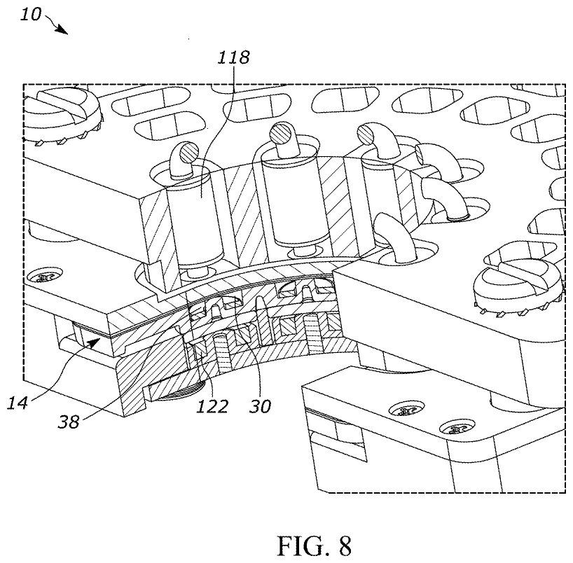

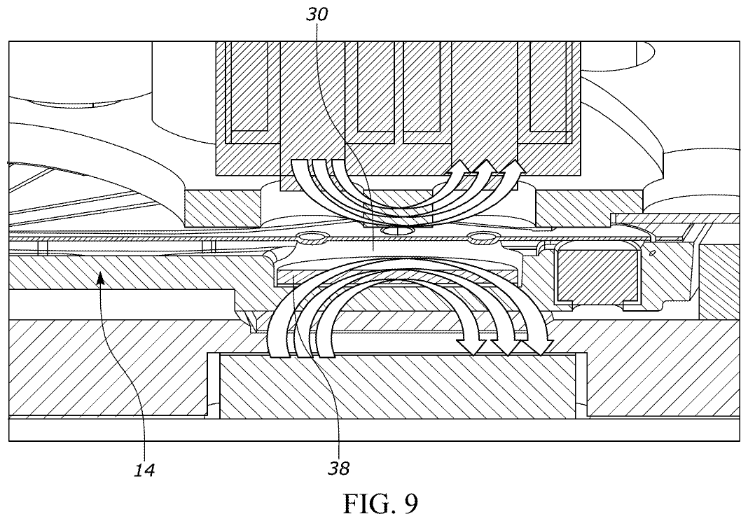

With reference to FIGS. 8 and 9, and as described above, the device 10 includes a plurality of ferromagnetic elements 38 positioned within the wells 30. In some examples, the ferromagnetic elements 38 are lifted and dropped, for example, by an electromagnet 118, and the velocity of the ferromagnetic elements 38 is measured by a position sensor 122 (e.g., inductance to digital converter). The sensitivity of the position sensor 122 is dependent on the size and location of the conductive target. Thus, sensitivity is maximized when the ferromagnetic element 38 and the position sensor 122 are substantially concentric (FIGS. 8 and 9 illustrating for example a substantially concentric ferromagnetic element 38 and position sensor 122, and the resulting magnetic and induction fields shown by arrows).

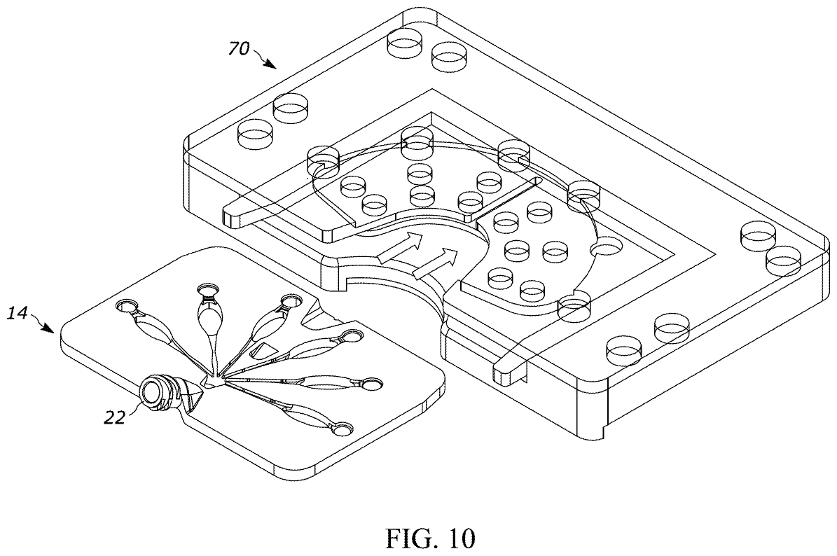

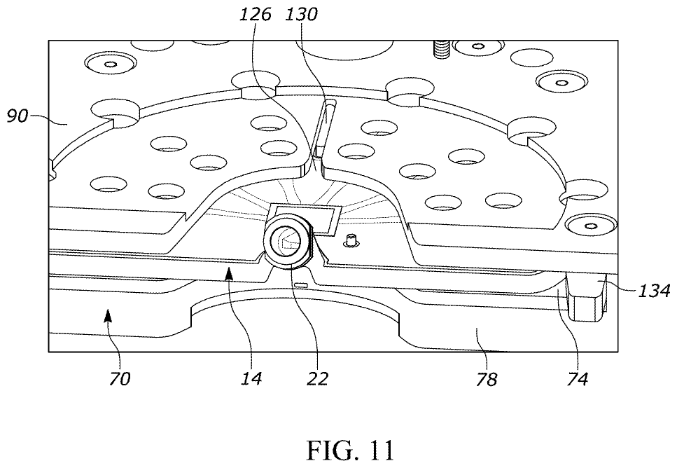

For this reason, and with reference to FIGS. 10 and 11, in some examples the device 10 includes at least one alignment feature to facilitate alignment of the cartridge 14, such that the ferromagnetic elements 38 of the cartridge 14 are substantially concentric with the position sensors of the device 10. The alignment feature or features may include, for example, at least one of a spring tab, an alignment slot, or an embossment on the heater block assembly 70 or the cartridge 14. With reference to FIG. 11, in the illustrated example, the alignment features include an alignment slot 126 on the heater block assembly 70 (e.g., on the upper plate 90 of the heater block assembly 70), and an embossment 130 (e.g., protrusion or tab) on the cartridge 14 that aligns with and slides into the alignment slot 126 on the heater block assembly 70. As seen in FIG. 11, each of the slot 126 and the embossment 130 is elongate, and narrow, such that the cartridge 14 is accurately, and tightly, aligned with the heater block assembly 70, and is guided linearly into the heater block assembly 70. The embossment 130 extends upwardly from the main body 18 and/or the cover 58 of the cartridge 14, and is located for example centrally between two of the inlet conduits 26. With reference to FIGS. 7 and 11, the alignment features additionally, or alternatively, include a spring tab or tabs 134 located within or adjacent the slot 74. In the illustrated example, the spring tabs 134 are coupled to the main body 78 of the heater block assembly 70, and generate counteracting/canceling spring forces to further facilitate alignment and centering of the cartridge 14 within the slot 74.

Other examples include different numbers and types and arrangements of alignment features. In some examples, the cartridge 14 includes the slot 126, and the heater block assembly 70 includes the embossment 130. In yet other examples, the heater block assembly 70 includes multiple slots 126, or multiple embossments 130, spaced at various locations, and the cartridge 14 includes corresponding embossments 130 and slots 126 that align with the slots 126 and the embossments 130 on the heater block assembly 70. In some examples, only spring tabs 134 are used to facilitate the alignment. Overall, the alignment features may guide (e.g., passively guide) the cartridge 14 to an appropriate location (e.g., within the heater block assembly 70) without precise control from the user. In other words, the alignment features themselves enable a precise alignment, without requiring the user to manually maneuver and align the cartridge 14.

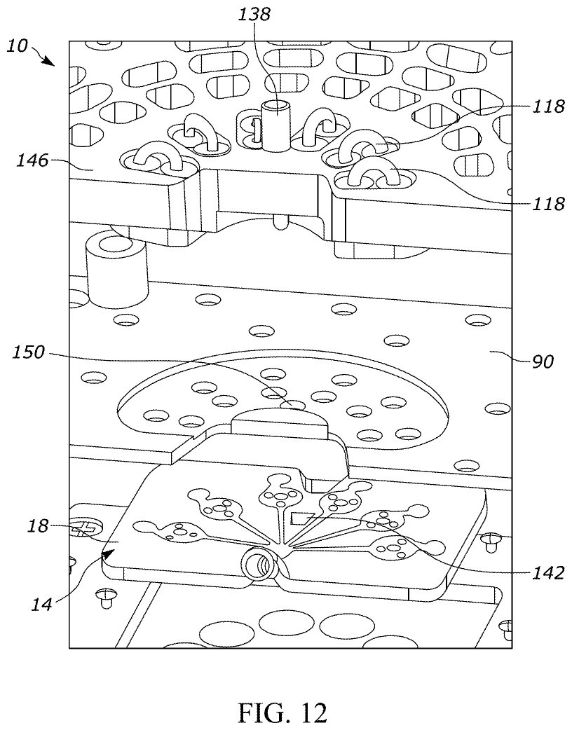

With reference to FIGS. 12-18, in some examples the device 10 also, or alternatively, includes at least one retention feature to retain the cartridge 14 within the cartridge slot 74 of the heater block assembly 70. The retention features may be passive features (i.e., features that mechanically lock the cartridge 14 in place without the assistance of a motorized component), or active features (i.e., features that use a motorized component to lock the cartridge 14 in place).

For example, as illustrated in FIG. 12, in some examples the retention feature includes a spring plunger 138 that is biased (e.g., by a spring) to move (e.g., upwardly or downwardly) toward the cartridge 14, to engage the cartridge 14. In the illustrated example, the main body 18 of the cartridge 14 includes a corresponding indentation 142 (e.g., slot or recess) along an upper surface of the main body 18 that is sized and shaped to receive a portion of the spring plunger 138. The spring plunger 138 is a passive retention feature. In the illustrated example, when the cartridge 14 is initially inserted into the slot 74, the spring plunger 138 is pressed up vertically against the biasing force. The spring plunger 138 and/or the cartridge 14 may include surfaces (e.g., curved or inclined surfaces) that engage one another to facilitate this initial upward movement of the spring plunger 138. When the cartridge 14 is inserted further, and is aligned within the slot 74, the spring plunger 138 is positioned over the indentation 142. The spring plunger 138 then presses down, via the biasing force, into the indentation 142, locking the cartridge 14 in place. In the illustrated example, the spring plunger 138 (and the electromagnets 118 described above) are coupled to an upper housing element 146 of the device 10, and the upper plate 90 of the heater block assembly 70 includes an aperture 150. The spring plunger 138 may be positioned over the aperture 150, and a lower portion of the spring plunger 138 may extend down through the aperture 150 and engage the cartridge 14. In some examples, the cartridge 14 maybe removed by pulling back on the cartridge 14 with a sufficient force (e.g., a predetermined force) to overcome the locked state, forcing the spring plunger 138 to again rise up vertically, and freeing the cartridge 14 to be pulled back and removed from the slot 74. In other examples the spring plunger 138 moves upwardly to engage the cartridge 14, or moves laterally to engage a side of the cartridge 14. In some examples, multiple spring plungers 138 are used to engage and retain the cartridge 14 in place within the slot 74.

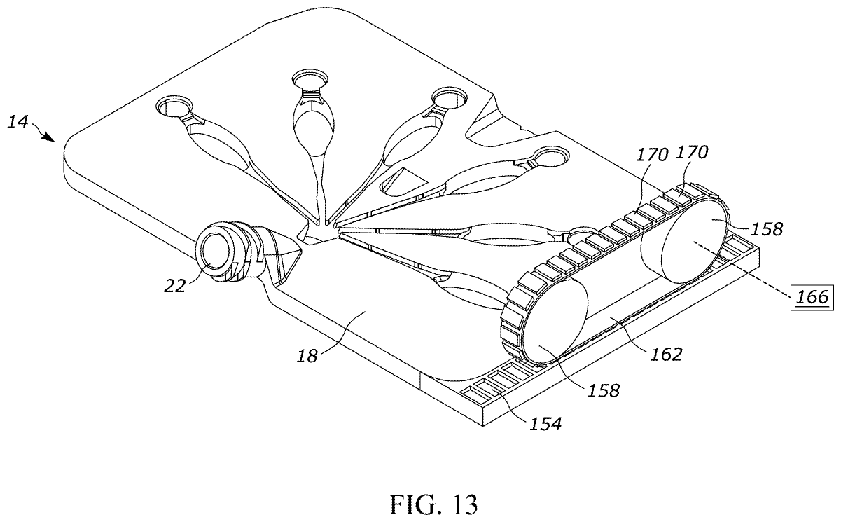

With reference to 13, in some examples the retention feature includes a rack and pinion system. In the illustrated example, the rack and pinion system includes a rack 154 located (e.g., integrally formed on) on a top surface of the main body 18 of the cartridge 14 (e.g., near an edge of the main body 18). The system also includes one or more pinions 158, which rotate and drive rotation of a belt 162 that is wrapped around the pinions 158. In some examples, one or more of the pinions 158 is coupled to a motor 166 that rotates the pinions 158. The motor 166 may be coupled, for example, to the controller 114 (FIG. 7). With continued reference to FIG. 13, in the illustrated example the belt 162 includes teeth 170 that engage the rack 154, thereby moving the cartridge 14. The system may be used, for example, to automatically move and insert the cartridge 14 into the slot 74, and may also be used to lock and retain the cartridge 14. For example, once the cartridge 14 has initially been inserted into the slot 74 (e.g., manually), the teeth 170 of the belt 162 may then engage and grab hold of the rack 154, and the cartridge 14 maybe pulled further into the slot 74 automatically by the motorized rotation of the pinions 158. The engagement of the teeth 170 with the rack 154 inhibits or prevents the cartridge 14 from moving out of the slot 74, thereby retaining the cartridge 14 within the slot 74. Other examples include different numbers and arrangements of racks and pinions than that illustrated. In some examples, the rack 154 is located centrally along the cartridge 14, and/or the cartridge 14 includes multiple racks 154. In some examples, the pinion 158 itself includes teeth and the belt 162 is not provided. Additionally, in some examples only a single pinion 158 is provided.

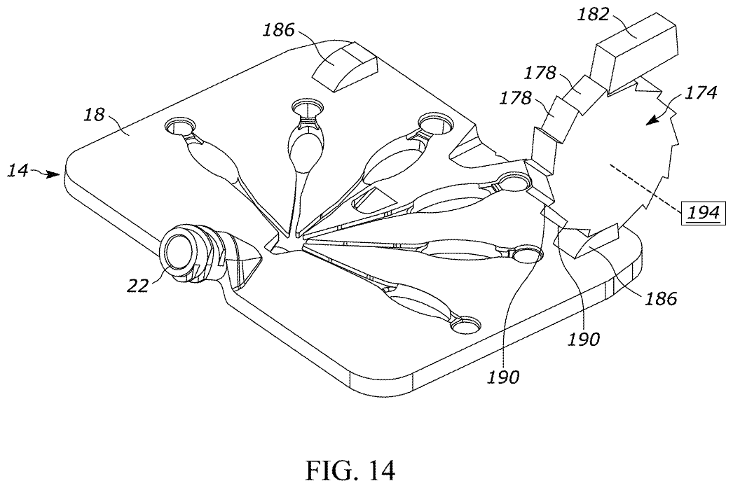

With reference to FIG. 14, in some examples the retention feature includes a ratchet system. In the illustrated example, the ratchet system includes a ratchet wheel 174 having ratchet teeth 178 along an outer periphery of the ratchet wheel 174. The ratchet system also includes a ratchet arm 182 that is sized and shaped to engage the teeth 178. In some examples, the ratchet arm 182 pivots, and/or rises and falls, to allow the ratchet wheel 174 to rotate underneath. In the illustrated example, the ratchet system also includes at least one embossment 186 on the main body 18 of the cartridge 14 (e.g., on an upper surface of the main body 18). When the cartridge 14 is inserted into the slot 74, the embossment 186 engages and/or presses the teeth 178 along the bottom of the ratchet wheel 174, causing a rotation of the ratchet wheel 174 (e.g., counterclockwise as seen in FIG. 14). The pivoting ratchet arm 182 rises and falls over the teeth 178 along the top of the ratchet wheel 174, and inhibits or prevents the ratchet wheel 174 from rotating in an opposite direction (e.g., clockwise). In some examples, a top surface of the embossment 186 engages a bottom surface of the teeth 178 tightly (e.g., frictionally), to inhibit or prevent the cartridge 14 from being pulled backwards (e.g., to the left in FIG. 14), thereby facilitating retention of the cartridge 14.

In the illustrated example, the teeth 178 along the bottom of the ratchet wheel 174 include flat regions 190 that face toward the injection port 22 (e.g., to the left in FIG. 14). In other examples, the teeth 178 are oriented opposite to that of the teeth 178 in FIG. 14, such that the flat regions 190 face away from the injection port 22 (e.g., to the right in FIG. 14) along the bottom of the ratchet wheel 174. The embossment 186 may be sized and shaped such that a portion of the embossment 186 engages the flat regions 190 facing away from the injection port 22, and the ratchet arm 182 may be positioned opposite that of FIG. 14, to prevent rotation (e.g., counterclockwise rotation) of the ratchet wheel 174. This engagement may also facilitate retention of the cartridge 14, and inhibit or prevent the cartridge 14 from being pulled away from the slot 74.

Additionally, and with continued reference to FIG. 14, in some examples the ratchet wheel 174 is coupled to a motor 194. The motor 194 may be coupled, for example, to the controller 114 (FIG. 7). The motor 194 may rotate the ratchet wheel 174, thereby automatically moving the cartridge 14 (e.g., to the right or left in FIG. 14) and/or align the cartridge 14. Other examples include different numbers and arrangements and orientations of ratchet wheels 174, teeth 178, ratchet arms 182, embossments 186, and/or motors 194 than that illustrated. In some examples, the ratchet system includes multiple ratchet wheels 174, multiple ratchet arms 182, and multiple embossments 186.

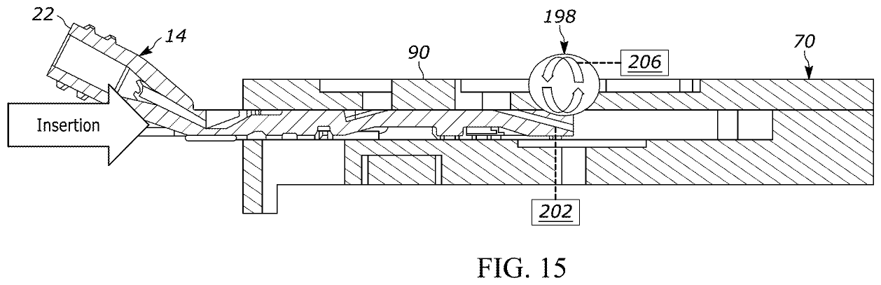

With reference to FIG. 15, in yet other examples the retention feature includes a roller 198 and/or a limit switch 202. In the illustrated example, the roller 198 is coupled to the heater block assembly 70 (e.g., to the upper plate 90), and to a motor 206. Both the motor 206 and the limit switch 202 may be coupled, for example, to the controller 114 (FIG. 7). In some examples, the roller 198 engages the cartridge 14 and automatically pulls the cartridge 14 into the heater block assembly 70. This insertion may also align the cartridge 14. The limit switch 202 determines a position of the cartridge 14. The limit switch 202 detects that the cartridge 14 has reached the roller 198. The controller 114 then sends a signal to the motor 206 to cause the roller 198 to rotate, thereby engaging and pulling the cartridge 14 further into the heater block assembly 70. In other examples, the limit switch 202 detects that the cartridge 14 has been fully inserted into the heater block assembly 70, and the controller 114 sends a signal to for the roller 198 to stop rotating. The engagement of the roller 198 with the cartridge 14 may retain the cartridge, and inhibit or prevent the cartridge 14 from being pulled out of the heater block assembly 70. In some examples, the cartridge 14 is removed by the roller 198 rotating in an opposite direction, thereby driving the cartridge 14 out of the heater block assembly 70.

With reference to FIGS. 7 and 11, and as described above, in some examples the device 10 includes spring tabs, such as spring tabs 134. The spring tabs may act to passively retain the cartridge 14 within the slot 74 (e.g., in addition to passively aligning the cartridge 14). Once the cartridge 14 has been inserted into the slot 74 and properly aligned, the spring tabs may snap back inwardly toward one another (e.g., laterally toward the cartridge 14), or snap away from each other (e.g., laterally away from the cartridge 14), and/or otherwise engage one or more surfaces of the heater block assembly 70, thereby locking and retaining the cartridge 14 in place within the slot 74.

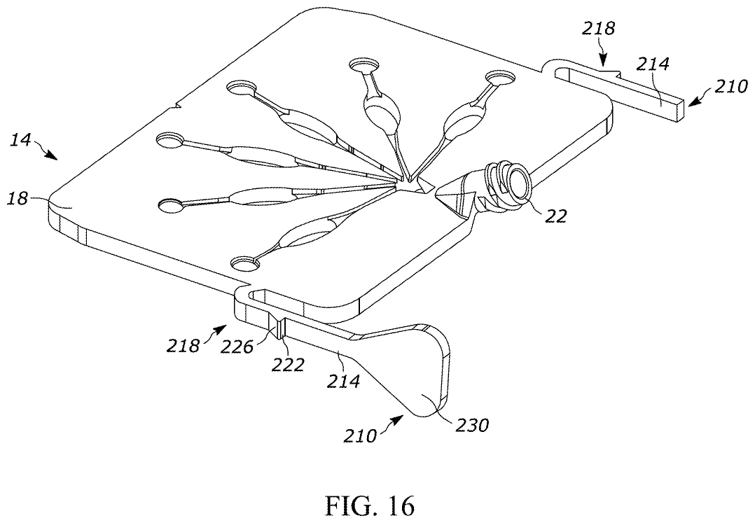

FIGS. 16-18 illustrate other examples of spring tabs that may be used to retain and/or align the cartridge 14. With reference to FIG. 16, in some examples the main body 18 of the cartridge 14 includes spring tabs 210 along opposite (e.g., lateral) sides of the main body 18. Each of the spring tabs 210 includes an elongate, flexible arm 214, and an embossment 218 on the arm 214. In the illustrated example, the embossment 218 is a protrusion that extends laterally away from the arm 214. The embossment 218 has a first (e.g., flat) surface 222, and a second (e.g., flat) surface 226 that is inclined relative to the first surface 222. In some examples, one of the arms 214 has an enlarged end 230. During insertion of the cartridge 14 into the heater block assembly 70, the inclined second surfaces 226 may engage for the example a portion (e.g. interior protrusion) of the main body 78 of the of the heater block assembly 70, forcing the arms 214 to flex laterally inwardly toward one another until the embossment 218 has passed by the portion of the main body 78. The arms 214 then flex (e.g., snap) back laterally outwardly, such that the first surface 222 is engaged behind the portion of the main body 78, thereby inhibiting or preventing the cartridge 14 from being pulled back out of the heater block assembly 70. During insertion of the cartridge 14, the biasing forces of the arms 214 also help to align the cartridge 14.

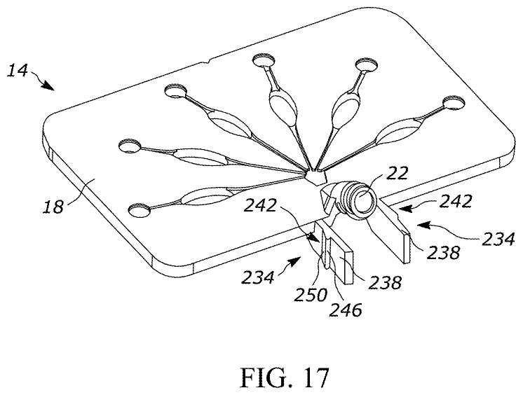

With reference to FIG. 17, in some examples the main body 18 of the cartridge 14 includes spring tabs 234 along a front of the cartridge 14, and adjacent to and on either side of the injection port 22. Each of the spring tabs 234 includes an elongate, flexible arm 238, and an embossment 242 on the arm 238. Similar to the embossment 218, the embossment 242 is a protrusion that extends laterally away from the arm 238. The embossment 242 has a first (e.g., flat) surface 246, and a second (e.g., flat) surface 250 that is inclined relative to the first surface 246. During insertion of the cartridge 14 into the heater block assembly 70, the inclined second surfaces 250 may engage for the example a portion (e.g. interior protrusion) of the main body 78 of the of the heater block assembly 70, forcing the arms 238 to flex laterally inwardly toward one another until the embossment 242 has passed by the portion of the main body 78. The arms 238 then flex (e.g., snap) back laterally outwardly, such that the first surface 246 is engaged behind the portion of the main body 78, thereby inhibiting or preventing the cartridge 14 from being pulled back out of the heater block assembly 70. During insertion of the cartridge 14, the biasing forces of the arms 238 help to align the cartridge 14.

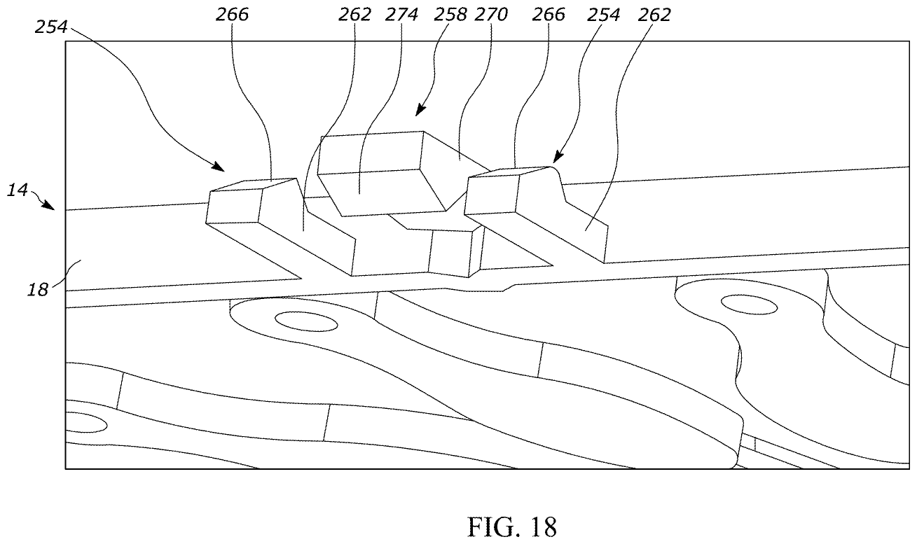

With reference to FIG. 18, in other examples the main body 18 of the cartridge 14 includes a first spring tab (or set of spring tabs) 254 that flexes in a first direction, and a second spring tab (or set of spring tabs) 258 that flexes in a second (e.g., opposite direction), to retain the cartridge 14. In the illustrated example, the main body 18 includes two spring tabs 254 that each include a flexible arm 262 and an inclined surface 266, and a single spring tab 258 that includes a flexible arm 270 and an inclined surface 274. During insertion of the cartridge 14, the inclined surfaces 266, 274 engage a portion or portions of the heater block assembly 70, forcing the two arms 262 to flex downwardly, and forcing the single arm 270 to flex upwardly. In some examples, the spring tabs 254, 258 grasp onto (e.g., grip) a portion of the heater block assembly 70 (e.g., from both above and below), and thus retain the cartridge 14 within the heater block assembly 70. Other examples include other numbers and arrangements of spring tabs 254, 258 than that illustrated.

The retention features described above may ensure that the cartridge 14 remains in the device 10 (e.g., within the heater block assembly 70) for the duration of a test. Additionally, the retention features may also function as an automatic cartridge 14 insertion and/or alignment mechanism.

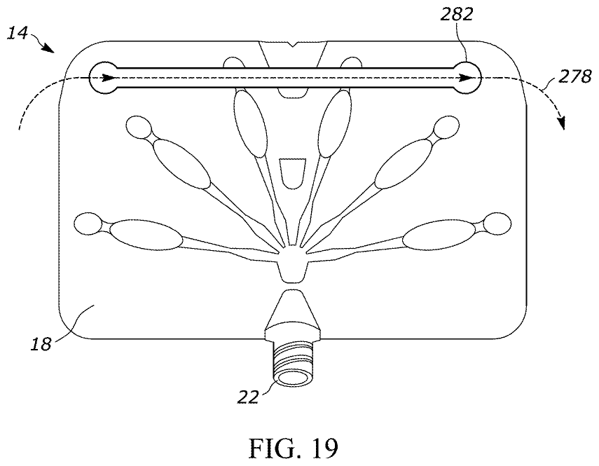

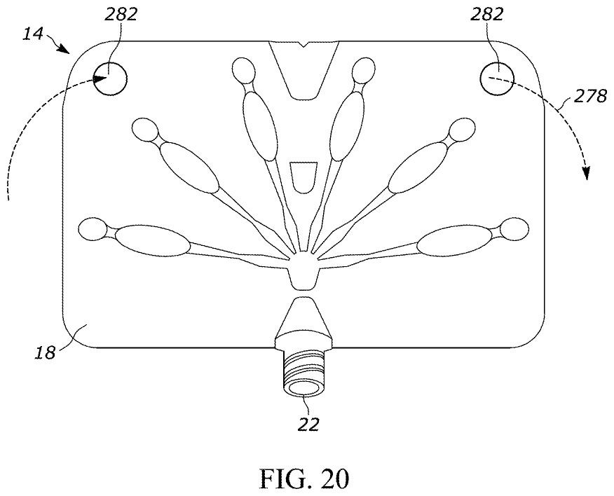

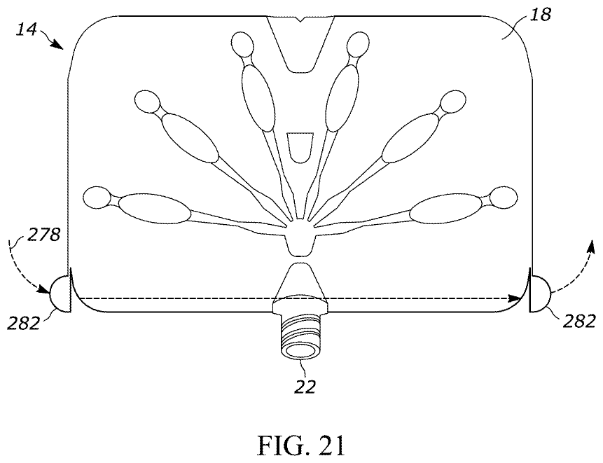

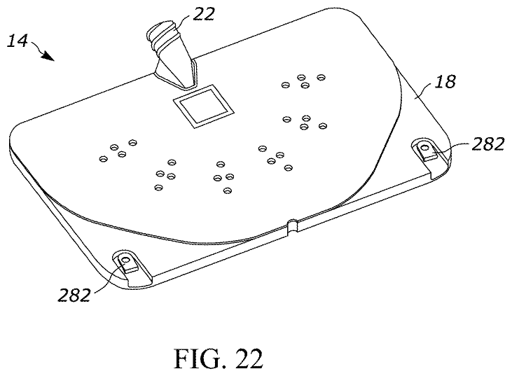

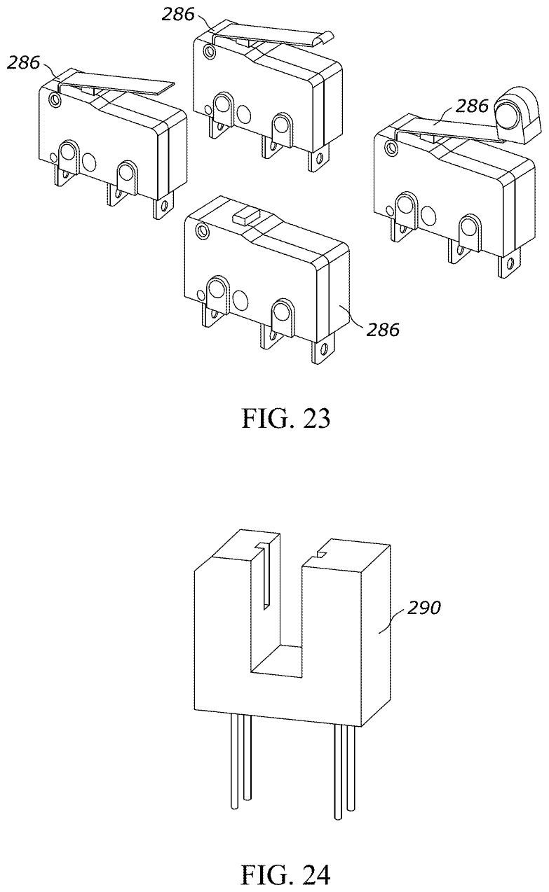

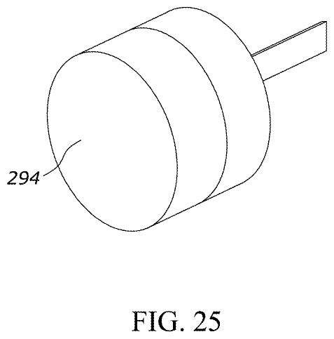

With reference to FIGS. 19-25, in some examples the device 10 also, or alternatively, includes at least one detection feature to detect a presence of the cartridge 14 within the cartridge slot 74 of the heater block assembly 70. The detection feature may for example, be electrical, electrochemical, optical, and/or acoustic. As illustrated in FIGS. 19-22, in some examples the detection feature includes a conductive pathway 278 that is closed and/or opened when the cartridge slot 74 is inserted into the heater bock assembly 70, to indicate whether the cartridge 14 is positioned within the heater block assembly 70. In the illustrated examples, the main body 18 of the cartridge 14 includes conductive material components 282 that close a normally open circuit when the cartridge 14 is fully inserted into the heater block assembly 70. With reference to FIG. 21, in some examples the conductive material component 282 is also an alignment and/or retention feature (e.g., flexible tab). With reference to FIG. 23, in some examples the detection feature is a mechanical switch 286 (e.g., a custom or on the shelf mechanical switch). With reference to FIG. 24, in some examples the detection feature is an optical sensor 290. For example, the cartridge 14 may block a light conduction pathway or may have a target that indicates to the sensor 290 that the cartridge 14 is fully and properly inserted. With reference to FIG. 25, in some examples the detection feature is an acoustic sensor 294 (e.g., simple sensor that detects when the cartridge 14 has been inserted, but is not sensitive to a position of the cartridge 14). Other examples include various other types of sensors, switches, or combinations thereof that may be used to detect a presence of the cartridge 14.

The detection features may verify for the user that the cartridge 14 has been properly inserted and appropriately aligned. For example, the detection features may emit a sound (e.g., “click” or “beep” or other sound), verifying detection and/or alignment of the cartridge 14. The sound may be emitted automatically via a mechanical engagement of components, or for example may be emitted via a speaker or other sound system associated with the device 10.

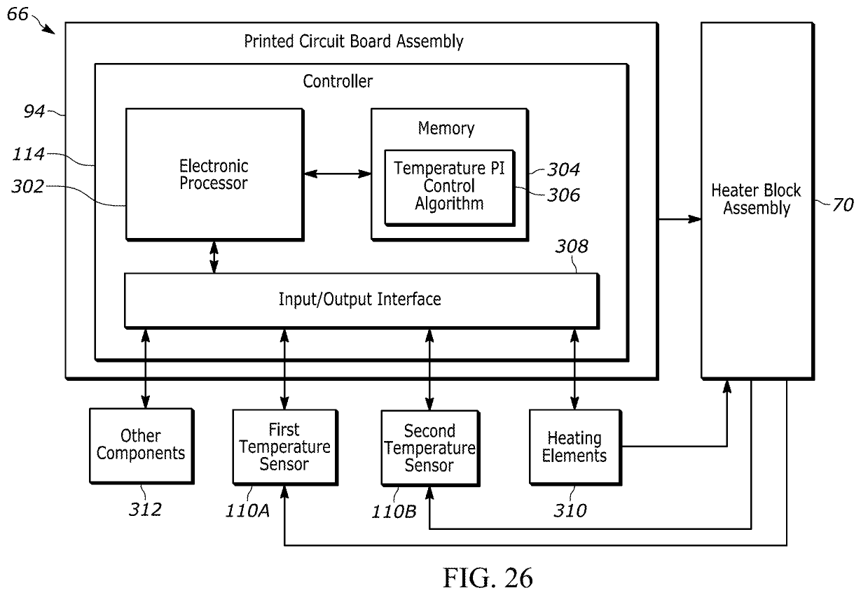

With reference to FIGS. 26-28, and as described above, the thermal control system 66 may monitor, adjust, and/or maintain the temperature of a fluid sample (e.g., blood) within the cartridge 14. FIG. 26 is a block diagram of one example of the thermal control system 66, which includes the printed circuit board assembly 94 and the heater block assembly 70. The printed circuit board assembly 94 includes the controller 114 (e.g., an electronic controller). The controller 114 may be connected to a power source (not shown). The power source provides power to the various components of the device 10 such as, but not limited to, the thermal control system 66, the printed circuit board assembly 94, and the controller 114. In some examples, the power source may provide alternating current (“AC”) power (e.g., 120V/60 Hz) from a plug that is coupled to a standard wall outlet or an external power source, and the thermal control system 66 may then filter, condition, and rectify the received power to output DC power. In other examples, the power source is a battery pack or battery module that is rechargeable and disposed within the device 10. In some instances, the battery pack or battery module provides DC power to the various components of the device 10. The controller 114 may control a level of power/heat output from the printed circuit board assembly 94 or from one or more heating elements not located on the printed circuit board assembly 94 to increase the temperature of the heater block assembly 70. In the illustrated example, the controller 114 includes, among other things, an electronic processor 302 (such as a programmable electronic microprocessor, microcontroller, or similar device), a memory 304 (for example, a non-transitory, machine readable medium), and an input/output interface 308. In some instances, the controller 114 also includes a plurality of electrical and electronic components that provide power, operational control, and protection to the components and modules within the controller 114. The electronic processor 302 is communicatively connected to the memory 304, the input/output interface 308, and the power source.

The input/output interface 308 is communicatively connected to the temperature sensor(s) 110 (illustrated for example as a first temperature sensor 110A and a second temperature sensor 110B), one or more heating elements 310, and other components 312 (e.g., the position sensor 122, the optical sensor 290, the acoustic sensor 294, and various other types of sensors, switches, or combinations thereof). Although illustrated as the first temperature sensor 110A and the second temperature sensor 110B, the thermal control system 66 may include more or fewer than the number of temperature sensors 110 shown. In some examples, the first temperature sensor 110A is a medical-grade integrated circuit (“IC”) temperature sensor. In some examples, the second temperature sensor 110B is a thermistor. In the illustrated example, the first temperature sensor 110A and the second temperature sensor 110B each sense a temperature of the heater block assembly 70. In other examples, the first temperature sensor 110A and the second temperature sensor 110B sense a temperature of the printed circuit board assembly 94, and/or the first intermediary plate 98, and/or the second intermediary plate 102. In some examples, the electronic processor 302 monitors the temperature of the heater block assembly 70 and controls the power supplied to the one or more heating elements 310 based on the temperature sensed by the first temperature sensor 110A. The one or more heating elements 310 may provide heat to the heater block assembly 70. In some examples, the electronic processor 302 verifies the accuracy of the temperature sensed by the first temperature sensor 110A based on the temperature sensed by the second temperature sensor 110B. In some examples, the first temperature sensor 110A and the second temperature sensor 110B each sense a temperature at the same location. For example, the first temperature sensor 110A and the second temperature sensor 110B each sense a temperature at the same location relative to the heater block assembly 70, and/or the printed circuit board assembly 94, and/or the first intermediary plate 98, and/or the second intermediary plate 102.

The electronic processor 302 obtains and provides information (for example, from the memory 304 and the input/output interface 308), and processes the information by executing one or more software instructions or modules capable of being stored, for example, in the memory 304. The software may include firmware, one or more applications, program data, filters, rules, one or more program modules, and other executable instructions. In some instances, the electronic processor 302 executes instructions stored in the memory 304 to perform the methods described herein. The memory 304 may include one or more non-transitory computer-readable media and may include a program storage area and a data storage area. The program storage area and the data storage area may include combinations of different types of memory, for example, read-only memory (“ROM”), random access memory (“RAM”), electrically erasable programmable read-only memory (“EEPROM”), flash memory, or other suitable digital memory devices.

In some examples, the memory 304 stores a temperature proportional-integral (“PI”) control algorithm 306. The temperature PI control algorithm 306 is implemented by the electronic processor 302 to determine temperature (for example, a temperature sensed by the first temperature sensor 110A or the second temperature sensor 110B) and, among other things, scale the amount of power supplied to the printed circuit board assembly 94 and/or the one or more heating elements 310 to increase a temperature of the heater block assembly 70. In some examples, the electronic processor 302, in coordination with software stored in the memory 304 and information from the first temperature sensor 110A and the second temperature sensor 110B, is configured to implement, among other things, the methods described herein.

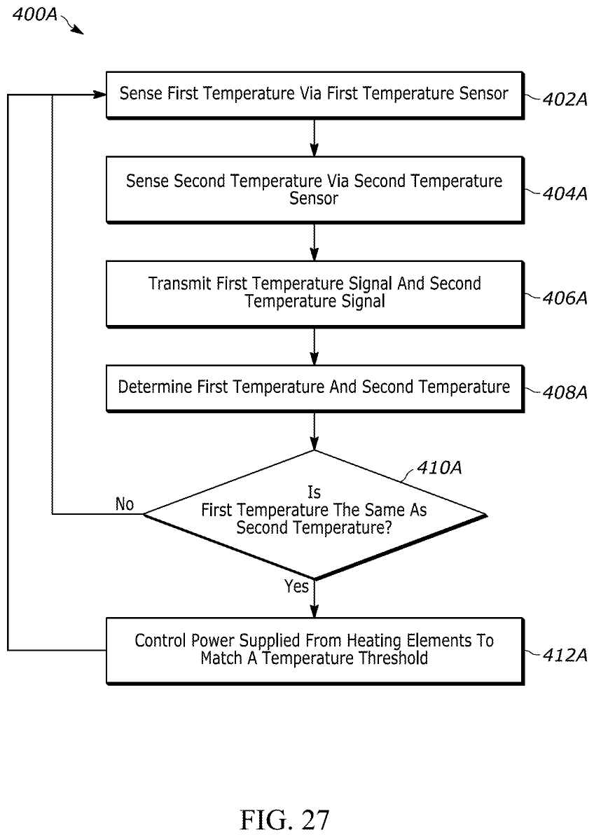

FIG. 27 illustrates an example flowchart of a method 400A for controlling the temperature of the heater block assembly 70. The method 400A is described as being executed by the components of the thermal control system 66. Additionally, while a particular order is provided, in some examples, the steps of the method 400A may be performed in a different order.

At step 402A, the first temperature sensor 110A senses a first temperature of the heater block assembly 70. For example, the first temperature sensor 110A senses a voltage indicative of the first temperature of the heater block assembly 70. At step 404A, the second temperature sensor 110B senses a second temperature of the heater block assembly 70. For example, the second temperature sensor 110B senses a voltage indicative of the second temperature of the heater block assembly 70. In some examples, the first temperature sensor 110A and the second temperature sensor 110B sense the same temperature of the heater block assembly 70 (e.g., the first temperature of the heater block assembly 70 is the same as the second temperature of the heater block assembly 70). In such examples, the first temperature sensor 110A and the second temperature sensor 110B sense a redundant temperature of the heater block assembly 70.

At step 406A, the first temperature sensor 110A transmits a first temperature signal to the electronic processor 302 and the second temperature sensor 110B transmits a second temperature signal to the electronic processor 302. For example, the first temperature sensor 110A transmits the first temperature signal including the voltage indicative of the first temperature and the second temperature sensor 110B transmits the second temperature signal including the voltage indicative of the second temperature.

At step 408A, the electronic processor 302 determines the first temperature of the heater block assembly 70 and the second temperature of the heater block assembly 70. For example, the electronic processor 302 receives the first temperature signal and the second temperature signal and determines the first temperature and the second temperature by executing the temperature PI control algorithm 306. In some instances, the first temperature and the second temperature are the same temperature value. In other instances, the first temperature is a different temperature value than the second temperature.

At step 410A, the electronic processor 302 determines whether the first temperature is the same as the second temperature. For example, the electronic processor 302 compares, by executing the temperature PI control algorithm 306, the first temperature to the second temperature to verify that the temperature sensed by the first temperature sensor 110A (i.e., the first temperature) is accurate. When the electronic processor 302 determines that the first temperature is different than the second temperature, the method 400A returns to step 402A to sense the first temperature of the heater block assembly 70 via the first temperature sensor 110A. In some examples, when the electronic processor 302 determines that the first temperature is different than the second temperature and a difference between the first temperature and the second temperature is outside of a tolerance range of temperature values, the electronic processor 302 determines that the temperature of the heater block assembly is unknown. In such examples, the electronic processor 302 may transmit an error indicating that the device 10 requires repair. When the electronic processor 302 determines that the first temperature is the same as the second temperature, the method 400A proceeds to step 412A.

At step 412A, the electronic processor 302 controls the amount of power supplied from the heating elements 310 and/or the printed circuit board assembly 94 to match a temperature threshold. In some instances, the temperature threshold may be a temperature of a blood sample during testing of the blood sample. For example, the electronic processor 302 controls the amount of current supplied to the heating elements 310 and/or the printed circuit board assembly 94 to increase the temperature provided to the heating block assembly 70. In some examples, the heating elements 310 and/or the printed circuit board assembly 94 include a plurality of copper traces (or other heat-generating electronics components) that generate the heat to be delivered from the heating elements 310 and/or the printed circuit board assembly 94 to the heater block assembly 70 based on the current supplied via the electronic processor 302. It should be understood that the electronic processor 302 may continue to control the amount of power supplied from the heating elements 310 and/or the printed circuit board assembly 94 until the temperature threshold is achieved. In other examples, the method 400A returns to step 402A to restart the method 400A.

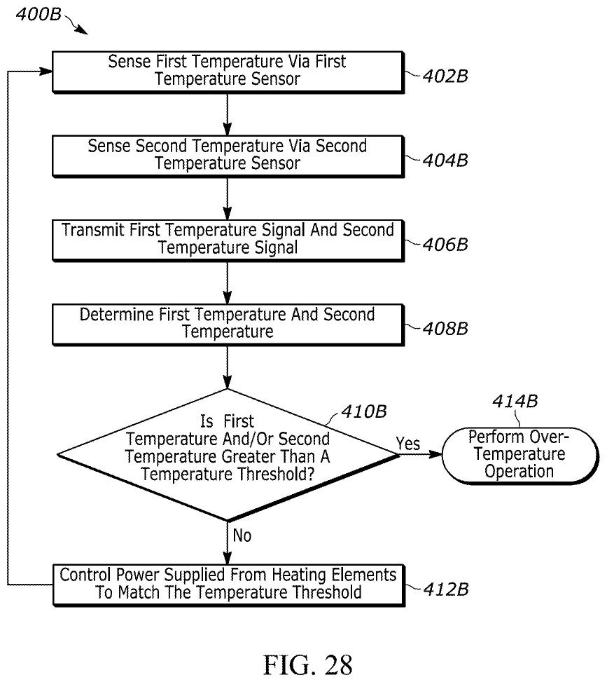

FIG. 28 illustrates an example flowchart of a method 400B for performing an over-temperature operation. The method 400B is described as being executed by the components of the thermal control system 66. Additionally, while a particular order is provided, in some examples, the steps of the method 400B may be performed in a different order. Although shown as a separate flowchart than the flowchart of method 400A of FIG. 27, in some examples, some or all of the steps of method 400B may be executed concurrently with some or all of the steps of method 400A. In other examples, the steps of method 400B are performed separately from the steps of method 400B.

At step 402B, the first temperature sensor 110A senses a first temperature of the heater block assembly 70. For example, the first temperature sensor 110A senses a voltage indicative of the first temperature of the heater block assembly 70. At step 404B, the second temperature sensor 110B senses a second temperature of the heater block assembly 70. For example, the second temperature sensor 110B senses a voltage indicative of the second temperature of the heater block assembly 70.

At step 406B, the first temperature sensor 110A transmits a first temperature signal to the electronic processor 302 and the second temperature sensor 110B transmits a second temperature signal to the electronic processor 302. For example, the first temperature sensor 110A transmits the first temperature signal including the voltage indicative of the first temperature and the second temperature sensor 110B transmits the second temperature signal including the voltage indicative of the second temperature.

At step 408B, the electronic processor 302 determines the first temperature of the heater block assembly 70 and the second temperature of the heater block assembly 70. For example, the electronic processor 302 receives the first temperature signal and the second temperature signal determines the first temperature and the second temperature by executing the temperature PI control algorithm 306. In some instances, the first temperature and the second temperature are the same temperature value. In other instances, the first temperature is a different temperature value than the second temperature.

At step 410B, the electronic processor 302 determines whether the first temperature and/or the second temperature is greater than the temperature threshold. For example, the electronic processor 302 compares, by executing the temperature PI control algorithm 306, the first temperature and the second temperature to verify that the first temperature and the second temperature are less than or equal to the temperature threshold. When the electronic processor 302 determines that the first temperature and the second temperature are less than or equal to the temperature threshold, the method 400B proceeds to step 412B. When the electronic processor 302 determines that the first temperature and/or the second temperature is greater than the temperature threshold, the method 400B proceeds to step 414B.

At step 412B, the electronic processor 302 controls the amount of power supplied from the heating elements 310 and/or the printed circuit board assembly 94 to match the temperature threshold. In some instances, the temperature threshold may be a temperature of a blood sample during testing of the blood sample. For example, the electronic processor 302 controls the amount of current supplied to the heating elements 310 and/or the printed circuit board assembly 94 to increase the temperature provided to the heating block assembly 70. In some examples, the heating elements 310 and/or the printed circuit board assembly 94 include a plurality of copper traces (or other heat-generating electronics components) that generate the heat to be delivered from the heating elements 310 and/or the printed circuit board assembly 94 to the heater block assembly 70 based on the current supplied via the electronic processor 302. It should be understood that the electronic processor 302 may continue to control the amount of power supplied from the heating elements 310 and/or the printed circuit board assembly 94 until the temperature threshold is achieved (e.g., 37° C.). In other examples, the method 400A returns to step 402A to restart the method 400A.

At step 414B, the electronic processor 302 performs an over-temperature operation of the thermal control system 66. For example, the electronic processor 302 controls the thermal control system 66 to shut down when the first temperature and/or the second temperature is greater than the temperature threshold. In some instances, the electronic processor 302 may turn off the power supplied to the thermal control system 66. In other examples, the electronic processor 302 may decrease the power supplied to the thermal control system 66 to decrease the temperature at a greater rate. In some examples, the over-temperature operation is a shut-down of the thermal control system 66 performed in hardware of the thermal control system 66.

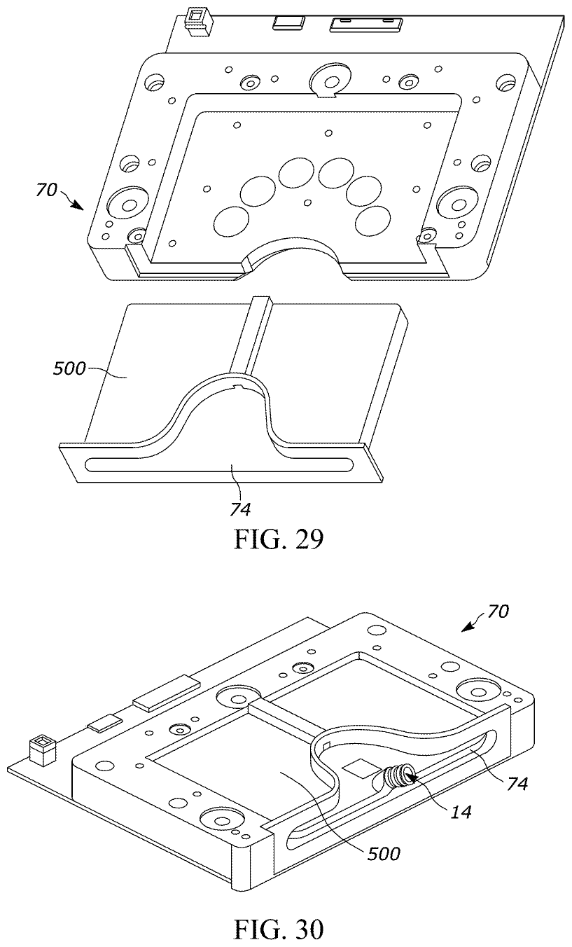

With reference to FIGS. 29 and 30, in some examples the device 10 includes a removable and washable slot housing 500 that forms the cartridge slot 74. The removable slot housing 500 facilitates easy cleaning of the cartridge slot 74, which may be beneficial, particularly if the device 10 is being used in an operating room with blood. In some examples, the slot housing 500 is an injection-molded alumina sleeve. The slot housing 500 may take the place of position and fill sensor caps. In the illustrated example, the alumina slot housing 500 permits conduction of heat, but does not affect any position and fill sensor performance as a metal component might. Alumina also tolerates harsh cleaners without degrading or corroding. The slot housing 500 may be reused several times, or can easily be replaced or interchanged. In yet other examples the slot housing 500 is a disposable plastic liner. The disposable plastic liner reduces the need for cleaning, and protects against spills or leaks.

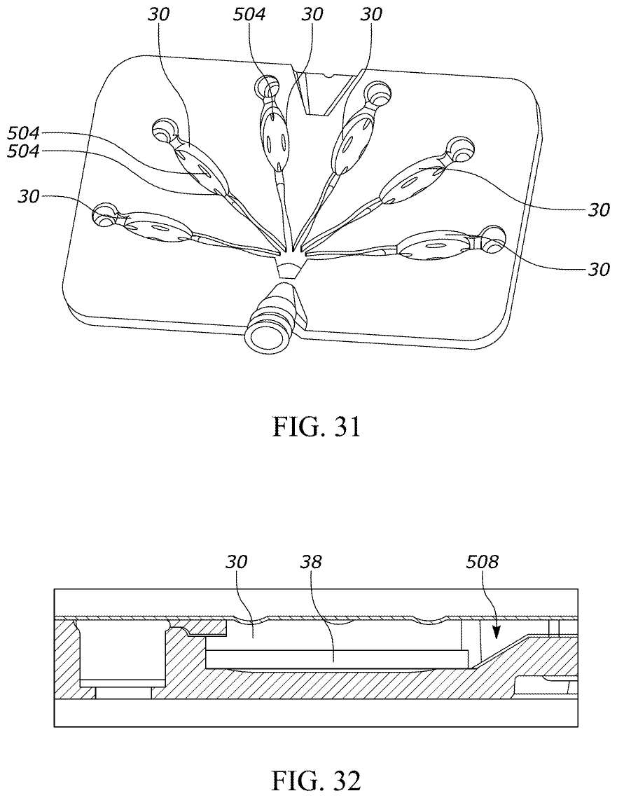

With reference to FIGS. 31 and 32, and as described above, in some examples the wells 30 have an oval (e.g., elliptical) shape. It has been discovered that elliptical-shaped wells 30 reduce the occurrence rate of large air entrapment in the wells 30 by providing a smoother transition and more laminar flow. With reference to FIG. 31, in some examples the wells 30 additionally, or alternatively, include standoffs 504 along the bottoms of the wells 30. The standoffs 504 allow fluid to flow under the ferromagnetic elements 38 and allow air to evacuate. With reference to FIG. 32, in some examples the wells 30 additionally, or alternatively, include ramped inlets 508. The ramped inlets 508 provide a smoother transition into the wells 30, provide a more laminar flow, reduce the likelihood of air being trapped at sharp corners, and help to encourage flow under the ferromagnetic elements 38.

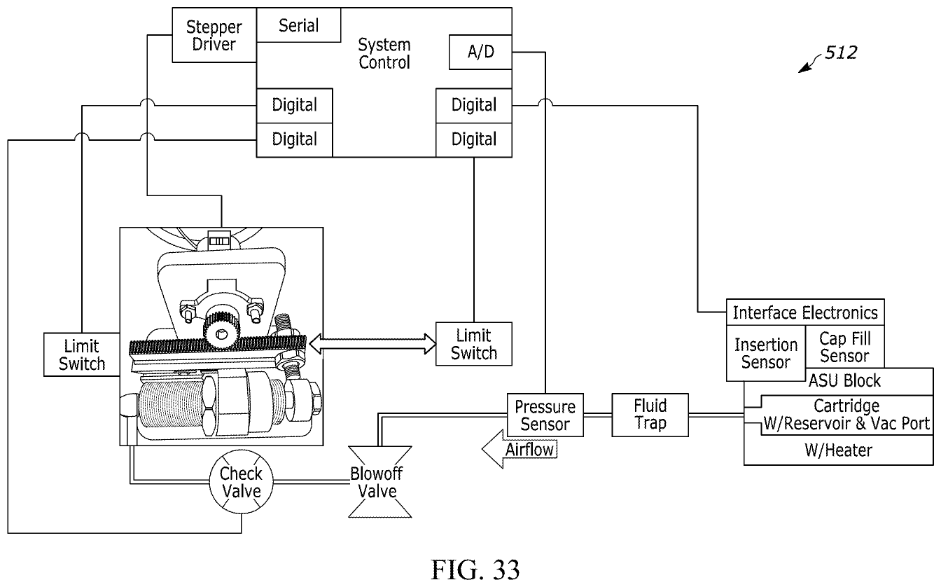

With reference to FIG. 33, in some examples the device 10 includes an automated vacuum fill system 512 (e.g., having system control, stepper driver, limit switches, pressure sensors, valves, interfaces, and/or other components) that allows the cartridge 14 and the wells 30 to be filled automatically (e.g., hands-free) with the sample fluid. The system 512 may reduce the chance of air entrapment, increase instrument accuracy and cycle time, and/or permit the user to focus more time on the patient. In the illustrated example, the system 512 includes a syringe pump that creates negative pressure in the cartridge wells 30. That pressure is then equilibrated with the fluid. The user is not required to manually control the fill speed or dispensed volume. In some examples, the system 512 provides higher cartridge reliability (e.g., inhibiting cartridge burst), and/or doubles as a fill sensor.

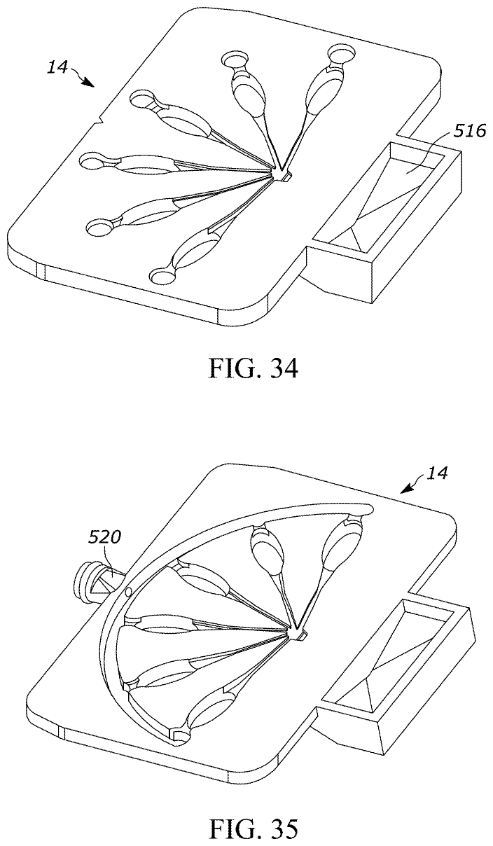

With reference to FIG. 34, in some examples the device 10 includes an external fluid reservoir 516 at a front of the cartridge 14. The user may dispense fluid into this reservoir 516 in preparation for an automatic fill of the cartridge 14. This may reduce interaction time (e.g., the user may simply fill and then walk away). The user is not required to control the dispensed volume, and excess fluid may be disposed.

With reference to FIG. 35, in some examples the device 10 includes a vacuum fill cartridge port 520 that hermetically seals with a syringe pump at a single point. The port 520 may leverage cartridge alignment features for port alignment. In some examples, fluid traps ensure that the pump remains uncontaminated. Additionally, sealing (e.g., O-ring) may be provided on the cartridge 14 to increase reliability.

Although various aspects and examples have been described in detail with reference to certain examples illustrated in the drawings, variations and modifications exist within the scope and spirit of one or more independent aspects described and illustrated.

What is claimed is:

1. A thermal control system for monitoring and maintaining a temperature of a fluid sample within a cartridge having a plurality of wells, the thermal control system comprising:
a heater block assembly having a cartridge slot sized and shaped to receive the cartridge within the heater block assembly, wherein the heater block assembly is comprised of thermally conductive material; and
a printed circuit board assembly coupled to the heater block assembly, wherein the printed circuit board assembly is configured to generate heat and deliver the heat to the heater block assembly, wherein the heater block assembly is configured to distribute the heat to the fluid sample located within the wells of the cartridge.

2. The thermal control system of claim 1, further comprising an intermediary plate coupled to the heater block assembly.

3. The thermal control system of claim 2, wherein the intermediary plate is configured to be positioned between the wells of the cartridge and the heater block assembly when the cartridge is received within the cartridge slot, and is configured to distribute the heat from the heater block assembly to the wells.

4. The thermal control system of claim 2, wherein the intermediary plate comprises a ceramic material.

5. The thermal control system of claim 2, wherein the intermediary plate is configured to distribute heat uniformly to each of the wells.

6. The thermal control system of claim 1, further comprising an intermediary plate coupled to both the heater block assembly and the printed circuit board assembly.

7. The thermal control system of claim 6, wherein the intermediary plate is positioned between an upper surface of the printed circuit board assembly and a lower surface of the heater block assembly, and is configured to distribute heat from the printed circuit board assembly to the heater block assembly.

8. The thermal control system of claim 7, wherein the intermediary plate comprises silicone.

9. The thermal control system of claim 1, wherein the heater block assembly includes a main body having an upper surface and a lower surface, wherein the heater block assembly includes an upper plate coupled to the upper surface of the main body, wherein the main body and the upper plate together define the cartridge slot.

10. The thermal control system of claim 9, wherein the printed circuit board assembly is coupled to the lower surface of the main body.

11. The thermal control system of claim 1, wherein the thermally conductive material of the heater block assembly is aluminum.

12. The thermal control system of claim 1, wherein the printed circuit board assembly includes a plurality of copper traces configured to generate heat to be delivered from the printed circuit board assembly to the heater block assembly.

13. The thermal control system of claim 1, further comprising:
a plurality of temperature sensors, each temperature sensor of the plurality of temperature sensors configured to sense a temperature of the heater block assembly, wherein each temperature sensor is coupled to the printed circuit board assembly; and
a controller configured to receive signals from the plurality of temperature sensors, the controller including an electronic processor configured to:
receive a first temperature signal via a first one of the plurality of temperature sensors;
receive a second temperature signal via a second one of the plurality of temperature sensors;
determine, based on the first temperature signal, a first temperature of the heater block assembly;
determine, based on the second temperature signal, a second temperature of the heater block assembly;
determine, based on the first temperature and the second temperature, whether the first temperature is the same as the second temperature; and
control, in response to the first temperature being the same as the second temperature, an amount of power supplied from the printed circuit board assembly.

14. The thermal control system of claim 13, wherein the electronic processor is further configured to:
determine, based on the first temperature and the second temperature, whether the first temperature or the second temperature is greater than a temperature threshold; and
control, in response to the first temperature and the second temperature being less than or equal to the temperature threshold, the amount of power supplied from the printed circuit board assembly to match the temperature threshold.

15. The thermal control system of claim 14, wherein the electronic processor is further configured to:
perform, in response to the first temperature or the second temperature being greater than the temperature threshold, an over-temperature operation.

16. The thermal control system of claim 15, wherein performing the over-temperature operation includes turning off the power supplied from the printed circuit board assembly or decreasing the amount of power supplied from the printed circuit board assembly.

17. A device for measuring the viscosity of a fluid, the device comprising:
a cartridge having
an injection port configured to introduce fluid into the cartridge;
a plurality of inlet conduits coupled to and extending away from the injection port;
a plurality of wells, wherein the inlet conduits extend from the injection port to the wells, and are configured to deliver the fluid from the injection port to the wells; and
the thermal control system of claim 1.

18. The device of claim 17, further comprising an alignment feature configured to facilitate alignment of the cartridge within the cartridge slot of the heater block assembly, wherein the alignment feature is at least one of a spring tab, an alignment slot, or an embossment on the heater block assembly or the cartridge.

19. The device of claim 17, further comprising a retention feature configured to retain the cartridge within the cartridge slot of the heater block assembly, wherein the retention feature is at least one of a spring plunger, a spring tab, a roller, a rack and pinion system, or a ratchet system on the heater block assembly or the cartridge.

20. The device of claim 17, further comprising a detection feature configured to detect a presence of the cartridge within the cartridge slot of the heater block assembly, wherein the detection feature is at least one of a conductive material component on the cartridge configured to close a circuit when the cartridge is within the cartridge slot, a mechanical switch, an optical sensor, or an acoustic sensor.
